(19) United States
(12) Patent Application Publication
(10) Pub. No.: US 2007/0020171 A1
(43) Pub. Date: Jan. 25, 2007

(54) Manganese dioxide, method and apparatus for producing the same, and battery active material and battery prepared by using the same

(76) Inventors: Shinichi Waki, Osaka (JP); Nobuharu Koshiba, Nara (JP); Tadafumi Ajiri, Miyagi (JP)

Correspondence Address: MCDERMOTT WILL & EMERY LLP, 600 13TH STREET, N.W., WASHINGTON, DC, 20005-3096, US

(21) Appl. No.: 11/491,973

(22) Filed: Jul. 25, 2006

(30) Foreign Application Priority Data
Jul. 25, 2005 (JP) JP 2005-214771
Jul. 25, 2005 (JP) JP 2005-214772

(51) Int. Cl. C01G 45/12; H01M 4/50; C01G 45/02; B01J 8/04

(52) U.S. Cl. 423/599; 429/224; 429/231.1; 252/182.1; 423/605; 422/189

(57) ABSTRACT

Manganese dioxide of this invention comprises monocrystalline particles with a β-type crystal structure. The use of such manganese dioxide as an active material of a battery makes it possible to improve the discharge characteristics and long-term reliability of the battery.

### BACKGROUND OF THE INVENTION

Manganese dioxide, which is an abundant natural resource and inexpensive, is widely used as a positive electrode active material for batteries. For example, manganese dioxide is used in the positive electrode of batteries, such as manganese or alkaline batteries whose negative electrode comprises zinc and lithium batteries whose negative electrode comprises lithium metal. Lithium batteries, in particular, have excellent storage characteristics, so they are used not only as the main power source but also as a back-up power source.

Conventionally, manganese dioxide for batteries has been produced by electrolysis, in which manganese mineral is dissolved in an acid aqueous solution such as an aqueous sulfuric acid solution and the resultant solution is electrolyzed (Japanese Laid-Open Patent Publication No. Hei 6-1509914). It has been reported that such electrolysis can provide secondary particles of several tens of Am.

Recently, electronic devices have been becoming more portable and multi-functional, thereby creating a demand for batteries with higher performance, such as improved discharge characteristics and long-term reliability. However, it cannot be said that conventional manganese dioxide obtained by electrolysis or solid phase synthesis fully satisfies such demand. For example, manganese dioxide obtained by electrolysis has a polycrystalline structure. Hence, it has crystal defects and/or grain boundaries, which are believed to interfere with the diffusion of hydrogen, lithium and other ions in the solid phase of the manganese dioxide, thereby causing degradation of the discharge characteristics of the battery.

It is believed that the particle size of a positive electrode active material affects the discharge characteristics of the battery. Manganese dioxide obtained by electrolysis or solid phase synthesis has a large mean particle size of tens of μm, so hydrogen and lithium ions must move a long distance inside the manganese dioxide. Thus, it can be expected that for example, pulverizing manganese dioxide results in an improvement in discharge characteristics. However, even if it is pulverized, the mean particle size of the pulverized particles is approximately 1 μm, which is not small enough. Further, such pulverization becomes a cause of high costs.

Fine particles with a size of 1 μm or less can be produced by using, for example, a sol-gel process or an evaporative decomposition process. These processes, however, require complicated steps and a long time to synthesize manganese dioxide, and it is thus difficult to use these processes in order to mass-produce manganese dioxide.

It is therefore an object of the present invention to provide manganese dioxide that can improve the discharge characteristics and long-term reliability of batteries, a method and apparatus for producing such manganese dioxide, and a battery active material and a battery that are prepared by using such manganese dioxide.

### BRIEF SUMMARY OF THE INVENTION

The present invention relates to manganese dioxide comprising monocrystalline particles with a β-type crystal structure. The mean particle size of the monocrystalline particles of manganese dioxide is preferably 0.1 μm or more and 1 μm or less. The monocrystalline particles are preferably shaped like needles. The manganese dioxide preferably comprises not less than 70 wt % of the monocrystalline particles with a β-type crystal structure. As used herein, the mean particle size of the monocrystalline particles refer to the average value of the maximum widths of the manganese dioxide monocrystalline particles. For example, in the case of needle like particles, the mean particle size of the monocrystalline particles refers to the average value of the lengths of the particles in the direction of crystal growth (length direction).

The present invention also pertains to a method for producing the above-described manganese dioxide. This production method includes the step of taking an aqueous solution containing manganese ions to a subcritical or supercritical state to thereby precipitate manganese dioxide.

In the production method, it is preferred that the aqueous solution containing manganese ions be heated at a temperature increase rate of 300° C./sec or more to thereby take it to a subcritical or supercritical state. It is further preferred that the aqueous solution containing manganese ions be directly mixed with subcritical or supercritical water to thereby heat it at the temperature increase rate of 300° C./sec or more.

In the production method, it is preferred that an oxidizing agent be dissolved in the aqueous solution containing manganese ions, and that the oxidizing agent comprise at least one selected from the group consisting of oxygen gas, ozone gas, hydrogen peroxide, and a nitric acid ion.

When the aqueous solution containing manganese ions is directly mixed with subcritical or supercritical water, the subcritical or supercritical water may contain an oxidizing agent dissolved therein. In this case, the same oxidizing agents as those listed above may be used.

The present invention is also directed to an apparatus for producing the above-mentioned manganese dioxide. This apparatus includes: a reaction tube with an inlet and an outlet; a first tube connected to the inlet of the reaction tube, the first tube being provided for supplying an aqueous solution containing manganese ions to the reaction tube; a second tube connected to the inlet of the reaction tube, the second tube being provided for supplying subcritical or supercritical water to the reaction tube; and means for collecting manganese dioxide, the means being provided downstream of the outlet of the reaction tube. The aqueous solution containing manganese ions is mixed with the subcritical or supercritical water at the inlet of the reaction tube. The reaction tube has an inner wall comprising an insulating inorganic material. The insulating inorganic material is preferably quartz or alumina.

The present invention also pertains to a positive electrode active material for a battery, which is synthesized by baking the above-mentioned manganese dioxide and a lithium compound. It should be noted, however, that the above-mentioned manganese dioxide can also be used as a positive electrode active material.

Further, the present invention relates to a battery including: a positive electrode comprising the above-mentioned manganese dioxide or the above-mentioned positive electrode active material for a battery; a negative electrode; a separator; and an electrolyte.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic view of an exemplary apparatus for producing manganese dioxide of the present invention;

FIG. 2 is a schematic view of another exemplary apparatus for producing manganese dioxide of the present invention;

FIG. 3 is a schematic view of a meeting point in the apparatus of FIG. 2 where a first tube and a second tube are joined to a reaction tube;

FIG. 4 is a schematic longitudinal sectional view of a coin battery produced in an Example;

FIG. 5 is an electron micrograph of manganese dioxide prepared in Example 1-2;

FIG. 6 is an X-ray diffraction chart of the manganese dioxide prepared in Example 1-2;

FIG. 7 is an electron micrograph of manganese dioxide prepared in Example 2-1;

FIG. 8 is an X-ray diffraction chart of the manganese dioxide prepared in Example 2-1; and

FIG. 9 is a schematic view of a meeting point in a production apparatus of manganese dioxide used in Comparative Examples 2-1 and 2-2 where a first tube and a second tube are joined to a reaction tube.

### DETAILED DESCRIPTION OF THE INVENTION

Manganese dioxide of this invention comprises monocrystalline particles with a β-type crystal structure. The use of such manganese dioxide as a positive electrode active material for a battery makes it possible to improve the discharge characteristics and long-term reliability of the battery.

That is, conventional manganese dioxide with a polycrystalline structure has crystal defects or grain boundaries, and these crystal defects and grain boundaries interfere with the diffusion of hydrogen, lithium and other ions in the active material particles. However, as described above, since the manganese dioxide of the present invention consists essentially of monocrystalline particles having almost no crystal defects and the like, it can improve the discharge characteristics relative to conventional manganese dioxide with a polycrystalline structure. Specifically, the use of manganese dioxide of the present invention makes it possible, for example, to suppress an increase in internal resistance during the discharge of the battery.

The manganese dioxide of the present invention contains almost no impurities such as lower oxides, acid components, and crystal water. Thus, even during storage, manganese ions are unlikely to leach out of the manganese dioxide. Further, since the manganese dioxide of the present invention consists essentially of monocrystalline particles, its corrosion at the grain boundaries is suppressed and its surface energy is low. Therefore, it is stable and resistant to decomposition compared with conventional manganese dioxide consisting essentially of polycrystalline particles, thereby making it possible to improve long-term reliability.

The mean particle size of the monocrystalline particles of manganese dioxide is preferably 0.1 μm or more and 20 μm or less, and more preferably 0.1 μm or more and 1 μm or less. Since the mean particle size of the monocrystalline particles is 20 μm or less, there is no need to pulverize manganese dioxide to obtain fine particles. Particularly when the mean particle size of the monocrystalline particles is 1 μm or less, the diffusion distance of hydrogen and lithium ions in the monocrystalline particles becomes short, so that the discharge characteristics of the battery can be further improved. However, if the mean particle size of the monocrystalline particles is less than 0.1 μm, it may become difficult to mix such manganese oxide with an auxiliary conductive agent and a binder in preparing an electrode.

It is preferred that the manganese dioxide of the present invention contain 70% by weight of monocrystalline particles with a β-type crystal structure.

The manganese dioxide of the present invention can be prepared by taking an aqueous solution containing manganese ions (Mn²⁺) to the subcritical or supercritical state. For example, when the aqueous solution containing manganese ions contains hydrogen peroxide as an oxidizing agent for promoting the oxidation of the manganese ions, manganese dioxide is produced in the following reaction formula:
Mn²⁺+2H₂O₂+2e⁻→MnO₂+2H₂O

The aqueous solution containing manganese ions can be taken to at least the subcritical state by making the temperature of the aqueous solution to 250° C. or higher and the pressure to 20 MPa or higher. Further, the aqueous solution containing manganese ions can be taken to the supercritical state by making the temperature of the aqueous solution to 374° C. or higher and the pressure to 22 MPa or higher.

Ions with an electric charge such as Mn²⁺ are generally stable in a liquid such as water, whereas nonpolar substances such as manganese dioxide are generally stable in a gas. Hence, particularly in the supercritical state, a solvent such as water becomes a gas from a liquid, so that non-polar manganese dioxide is readily produced.

In the supercritical state, the solubility of a metal oxide such as manganese dioxide into water sharply decreases under a given pressure when the temperature of the water is increased. Hence, in the supercritical state, by increasing the temperature under a given pressure, it becomes possible to promote the precipitation of manganese dioxide as a reaction product.

When a metal oxide is produced by hydrothermal synthesis at relatively low temperatures of approximately 100 to 200° C., crystal water and/or compounds containing a hydroxyl group are usually incorporated in the resultant oxide. On the other hand, when a metal oxide is synthesized at such high temperatures as in the supercritical state, almost no crystal water or the like is incorporated in the resultant oxide, since water is in the form of a gas in the supercritical state. Further, at such high temperatures, highly crystalline fine particles of manganese dioxide can be synthesized.

Accordingly, it is believed that performing synthesis in the subcritical or supercritical state as in the present invention promotes the production of an oxide with a high degree of crystallinity, thereby resulting in monocrystalline fine particles of the oxide.

Particularly, monocrystalline particles of manganese dioxide with a β-type crystal structure and a mean particle size of 0.1 μm or more and 1 μm or less can be produced by heating an aqueous solution containing manganese ions at a temperature increase rate of 300° C./sec or more and taking it to the subcritical state or supercritical state.

Methods for preparing the manganese dioxide of the present invention are hereinafter described specifically.

(Production Method 1)

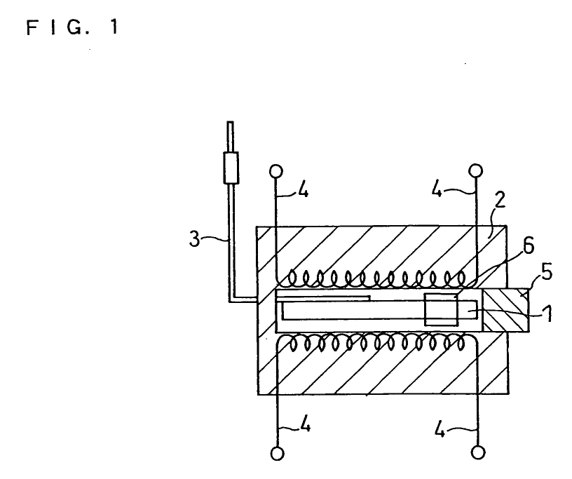

Manganese dioxide of the present invention, particularly manganese dioxide consisting essentially of monocrystalline particles with a mean particle size of larger than 1 μm and not larger than 20 μm, can be produced, for example, by taking an aqueous solution containing manganese ions to the subcritical or supercritical state, using an apparatus as illustrated in FIG. 1.

The apparatus as illustrated in FIG. 1 includes a tubular furnace 2 equipped with heating wires 4 and a tube 1 disposed in the tubular furnace 2. The tube 1 contains an aqueous solution containing manganese ions (raw material aqueous solution). The tube 1 is secured in the tubular furnace 2 by a holder 6. The space inside the tubular furnace 2, in which the tube 1 is disposed, is sealed with a stopper 5. The tubular furnace 2 is equipped with the heating wires 4 near the tube 1. The tubular furnace 2 is also equipped with a thermocouple 3, which is used to measure the temperature inside the tubular furnace 2.

Using this apparatus, manganese dioxide can be produced as follows.

First, a raw material aqueous solution is introduced into the tube 1, which is then sealed. The raw material aqueous solution is prepared, for example, by dissolving a water-soluble manganese salt in distilled water. Various manganese salts may be used, and examples include Mn(NO₃)₂ and MnSO₄.

The concentration of manganese ions contained in the raw material aqueous solution is preferably 0.01 to 5 mol/L. If the manganese ion concentration is lower than 0.01 mol/L, the amount of manganese dioxide produced decreases. If the manganese ion concentration is higher than 5 mol/L, the yield of manganese dioxide lowers.

After the raw material aqueous solution has been sealed in the tube 1, the tube 1 is inserted in the tubular furnace 2. The amount of the raw material aqueous solution sealed in the tube 1 is adjusted such that an intended pressure is achieved at a predetermined temperature inside the tubular furnace 2. This pressure is calculated from Steam Table on the assumption that the raw material aqueous solution is pure water. For example, in consideration of the fact that the density of water at a reaction temperature of 400° C. and a reaction pressure of 30 MPa is 0.35 g/cm³, if the volume of the tube 1 is, for example, 10 cm³, 3.5 g of the raw material aqueous solution is sealed in the tube 1.

Next, the tube 1 is heated to a predetermined temperature by the tubular furnace 2 to take the raw material aqueous solution to the subcritical or supercritical state. The predetermined temperature is maintained for a predetermined reaction time (e.g., about 5 to 20 minutes) to synthesize manganese dioxide. The raw material aqueous solution can be taken to at least the subcritical state by making the temperature to 250° C. or higher and the pressure to 20 MPa or higher, although it depends on the conditions such as the kind of the raw material aqueous solution. It is preferred that the raw material aqueous solution be taken to the supercritical state by adjusting the heating temperature and the amount of the raw material aqueous solution sealed in the tube 1. The raw material aqueous solution can be taken to the supercritical state by making the temperature to 374° C. or higher and the pressure to 22 MPa or higher. The speed of temperature increase up to the predetermined temperature is determined, for example, by the performance of the tubular furnace. The time necessary to increase the temperature of the raw material aqueous solution to the predetermined temperature is usually about 30 seconds to 2 minutes. For example, the temperature increase rate can be set to 4° C./sec in the above apparatus.

The heating temperature by the tubular furnace 2 is controlled by using the thermocouple 3 which measures the temperature inside the tubular furnace.

After the lapse of the predetermined reaction time, the tube 1 is removed from the tubular furnace 2 and placed, for example, in a cold bath in order to promptly stop the reaction. Subsequently, solid matter precipitated in the tube 1 is filtered and washed to obtain fine particles of manganese dioxide, which is a reaction product.

This production method can produce fine monocrystalline particles of manganese dioxide with a mean particle size of larger than 1 μm and not larger than 20 μm, preferably larger than 1 μm and not larger than 10 μm. Thus, there is no need to pulverize the resultant manganese dioxide to obtain fine particles. Further, this production method can produce manganese dioxide with high yields.

As used herein, the mean particle size of monocrystalline particles refers to the average value of the largest diameters of manganese dioxide monocrystalline particles. For example, in the case of needle-like particles, it refers to the average value of the lengths of the particles in the direction of crystal growth (length direction).

The raw material aqueous solution may contain an oxidizing agent in order to promote the oxidation of manganese ions. Exemplary oxidizing agents which may be used include oxygen gas, ozone gas, hydrogen peroxide, and a nitric acid ion. They may be used singly or in combination of two or more of them. The inclusion of such an oxidizing agent makes it possible to promptly oxidize Mn²⁺ to Mn⁴⁺.

For example, by using Mn(NO₃)₂, NO₃⁻ ions can be added to the raw material aqueous solution. The NO₃⁻ ions can promote the oxidation of Mn²⁺ ions to Mn⁴⁺ ions.

Further, the tube 1 contains air, and oxygen in the air also serves as an oxidizing agent. It is thus preferred that the gas phase in the reaction tube 1 contain oxygen gas. In order to promote the oxidation reaction, it is preferred to increase the amount of oxygen gas contained in the gas phase of the tube 1.

As the oxidizing agent, it is preferred to use nitric acid ions and hydrogen peroxide together. Hydrogen peroxide easily decomposes into oxygen gas and water when heated. Particularly in the supercritical condition, oxygen gas and the raw material aqueous solution form a uniform phase and, hence, when the oxidizing agent contains nitric acid ions and hydrogen peroxide, a better oxidation reaction field can be formed.

(Production Method 2)

Manganese dioxide consisting essentially of monocrystalline particles with a mean particle size of 0.1 μm or more and 1 μm or less can be produced by heating an aqueous solution containing manganese ions (raw material aqueous solution) at a temperature increase rate of 300° C./sec or more to take it to the subcritical or supercritical state.

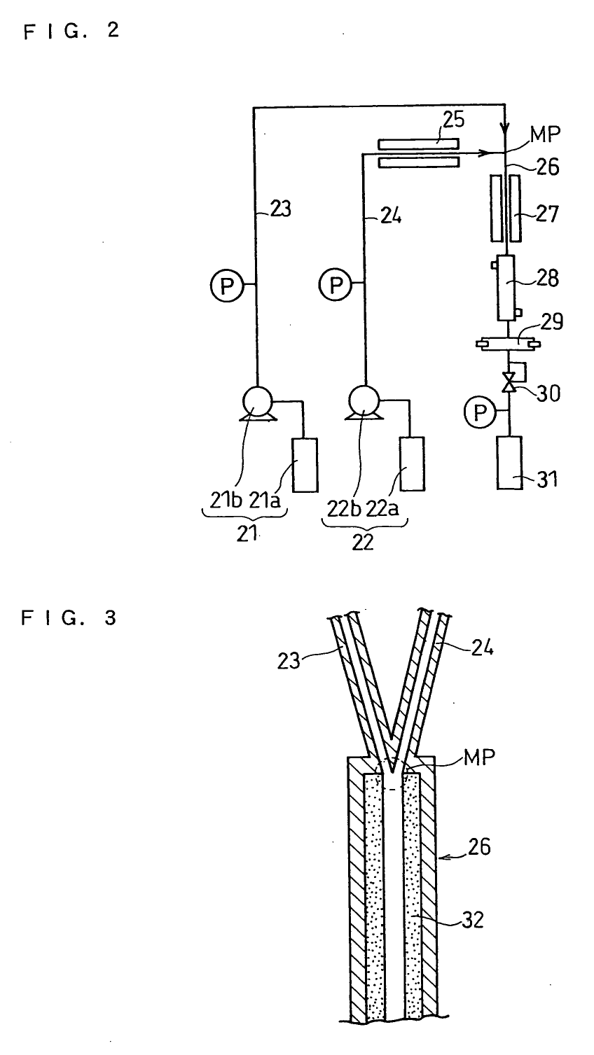

Such manganese dioxide can be produced, for example, by using an apparatus as illustrated in FIG. 2. With the apparatus of FIG. 2, distilled water is heated to a predetermined temperature under a predetermined pressure to prepare subcritical or supercritical water. The resultant subcritical or supercritical water is directly mixed with a raw material aqueous solution, and the resultant raw material aqueous solution is heated at a temperature increase rate of 300° C./sec or higher to take it to the subcritical or supercritical state.

The apparatus of FIG. 2 includes a reaction tube 26, a first supply unit 21 for supplying an aqueous solution containing manganese ions to the reaction tube 26 through a first tube 23, and a second supply unit 22 for supplying subcritical or supercritical water to the reaction tube 26 through a second tube 24. This apparatus further includes a tubular electric furnace 25 provided for the second tube 24, means 29 for collecting manganese dioxide that is provided downstream of the reaction tube 26, a tubular electric furnace 27 provided for the reaction tube 26, a heat exchanger 28 for cooling a reaction liquid, a back-pressure regulating valve 30 for lowering the pressure of the reaction liquid, and a reservoir 31. The inner wall of the reaction tube 26 comprises an insulating inorganic material.

The first supply unit 21 comprises a tank 21 for storing an aqueous solution containing manganese ions and a pump 21b for supplying the aqueous solution containing manganese ions at a predetermined pressure. The second supply unit 22 comprises a tank 22 for storing distilled water and a pump 22b for supplying the distilled water at a predetermined pressure. As the pumps 21b and 22b, for example, non-pulsation pumps may be used.

The distilled water supplied to the second tube 24 by the second supply unit 22 is heated to 250° C. or higher by the tubular electric furnace 25 that is provided for the second tube 24, so that the distilled water is taken to the subcritical or supercritical state. At this time, depending on the subcritical or supercritical state that is intended to achieve, a predetermined pressure of 20 MPa or higher is applied to the distilled water by the second supply unit 22.

The first tube 23 and the second tube 24 are connected to the inlet of the reaction tube 26. At the inlet of the reaction tube, the aqueous solution containing manganese ions and the subcritical or supercritical water are mixed together. FIG. 3 illustrates an exemplary meeting point (MP) where the first tube 23 and the second tube 24 are joined to the reaction tube 26.

In FIG. 3, the raw material aqueous solution supplied from the first tube 23 and the subcritical or supercritical water supplied from the second tube 24 are mixed together at the meeting point (MP) where the first tube 23 and the second tube 24 are joined to the reaction tube 26, to form a reaction liquid. When the raw material aqueous solution comes into contact with the subcritical or supercritical water, it is heated at a temperature increase rate of 300° C./sec or higher so that it is taken to the subcritical or supercritical state. It should be noted that a predetermined pressure of 20 MPa or higher is applied to the raw material aqueous solution by the first supply unit 21 in order to take it to the subcritical or supercritical state. The method for connecting the first and second tubes with the reaction tube is not limited to that as illustrated in FIG. 3 and any method may be used as long as the raw material aqueous solution flowing through the first tube can be mixed with the subcritical or supercritical water flowing through the second tube at an upstream end of the reaction tube.

The resultant reaction liquid flows through the reaction tube 26. At this time, the reaction liquid is heated by the tubular electric furnace 27 such that its subcritical or supercritical state is maintained.

After having flown though the reaction tube 26 of a predetermined length, the reaction liquid is cooled by a double-tube heat exchanger 28 that is provided on the downstream-side of the reaction tube 26. The cooled reaction liquid passes through the collecting means 29 such as an in-line filter and solid matter is deposited in the collecting means 29. By washing the solid matter, manganese dioxide can be obtained. After the reaction liquid has passed through the collecting means 29, the pressure is lowered by the back-pressure regulating valve 30 that is placed downstream of the collecting means 29. The reaction liquid is then stored in the reservoir 31.

As illustrated in FIG. 3, the inner wall 32 of the reaction tube 26 of this apparatus comprises an insulating inorganic material. When an insulating inorganic material is used, production of crystal nuclei of manganese dioxide does not occur at the interface between the reaction liquid and the reaction tube but occurs only in the reaction liquid, unlike the use of a metal material such as stainless steel. It is therefore possible to prevent clogging of the apparatus.

The insulating inorganic material is preferably quartz glass or alumina. These materials are insulators and stable even in the supercritical state. Hence, the use of these materials makes it possible to synthesize manganese dioxide continuously and stably over an extended period of time.

According to this production method, the aqueous solution containing manganese is heated at a temperature increase rate of 300° C./sec or higher. As a result, it is possible to instantaneously make manganese dioxide highly oversaturated and, therefore, to produce crystalline nuclei of 1 μm or less. Further, since a plurality of crystalline nuclei of manganese dioxide are produced simultaneously, it is possible to prevent polycrystallization due to agglomeration of nuclei and production of secondary nuclei at the crystal surface. Particularly in the supercritical state, it is possible to suppress growth of manganese dioxide crystals caused by redissolution precipitation of crystals (Ostwald ripening phenomenon). Therefore, monocrystalline particles of manganese dioxide with a mean particle size of 1 μm or less can be produced with high yields.

The apparatus of FIG. 2 allows the raw material aqueous solution to be continuously mixed with the subcritical or supercritical water, thereby making it possible to continuously synthesize manganese dioxide.

According to this method, since fine particles of manganese dioxide with a mean particle size of 1 μm or less can be synthesized, there is no need to pulverize the manganese dioxide obtained. It should be noted, however, that when the temperature increase rate of the aqueous solution containing manganese ions is less than 300° C./sec, growth of crystalline nuclei is facilitated, so that the mean particle size may become larger than 1 μm.

As described above, the aqueous solution containing manganese ions may be heated at a temperature increase rate of 300° C./sec or higher by directly mixing it with subcritical or supercritical water. Subcritical or supercritical water may be produced by using methods known in the art. Alternatively, the aqueous solution containing manganese ions may be directly heated at a temperature increase rate of 300° C./sec or higher by using a heating device.

In this method, an aqueous solution prepared by dissolving a water-soluble manganese salt in distilled water may also be used as the aqueous solution containing manganese ions in the same manner as in Production Method 1. The concentration of manganese ions contained in the aqueous solution containing manganese ions is preferably 0.01 to 5 mol/L.

The aqueous solution containing manganese ions may contain an oxidizing agent in order to promote the oxidation of the manganese ions. When the aqueous solution containing manganese ions is directly mixed with subcritical or supercritical water, the aqueous solution containing manganese ions may contain an oxidizing agent, or the subcritical or supercritical water may contain an oxidizing agent. As the oxidizing agent, the same substances as those in Production Method 1 may be used.

When manganese dioxide is produced in a reaction field where a gas phase is present, the oxidation of Mn²⁺ may be promoted not only by adding an oxidizing agent to the raw material aqueous solution but also by causing the gas phase to contain oxygen gas, in the same manner as the above. In order to promote the oxidation reaction, it is preferred to increase the amount of oxygen gas contained in the gas phase in the reaction tube. Particularly in the supercritical state, the aqueous solution containing manganese ions and a gas such as oxygen gas can form a uniform phase. Hence, the manganese ions are readily oxidized and manganese dioxide can be produced with high yields.

As described above, the production method according to this embodiment can produce monocrystalline particles of manganese dioxide with a B-type crystal structure and a mean particle size of 0.1 μm or more and 1 μm or less with a high yield.

The manganese dioxide obtained by the above-described Production Methods 1 and 2 can be used as a positive electrode active material for batteries. Also, the manganese dioxide obtained may be used as the starting substance to synthesize a compound for use as a positive electrode active material of batteries. The compound synthesized by using the above-described manganese dioxide as the starting substance is highly pure, highly crystalline, and small in mean particle size. Accordingly, when such a compound is used as an active material of a battery, the battery is improved in charge/discharge characteristics and long-term reliability.

For example, by baking a mixture of the above-mentioned manganese dioxide and a lithium compound, lithium-containing manganese oxides and spinel-type lithium manganese oxides having high purity and high crystallinity can be obtained. Exemplary lithium compounds which may be used include lithium hydroxides and lithium oxides.

Such manganese oxides can be used as an active material for batteries.

Such manganese dioxide and/or manganese oxides can be used as positive electrode active materials of, for example, lithium primary batteries, lithium secondary batteries, alkaline batteries and manganese batteries.

The present invention is hereinafter described by way of Examples. These Examples, however, are merely indicative of exemplary embodiments of the present invention, and the present invention is not to be construed as being limited to these Examples.

### EXAMPLE 1-1

(Preparation of Manganese Dioxide)

Manganese dioxide was prepared by using the apparatus as illustrated in FIG. 1.

An aqueous manganese nitrate solution of 1.31 cm³ (1.31 g) (manganese ion concentration: 1 mol/L) was sealed in a tube with a volume of 5 cm³ made of stainless steel (SUS316). The tube containing the aqueous manganese nitrate solution was inserted into the tubular furnace, and the solution was reacted at a reaction temperature of 400° C. for 10 minutes. At this time, the pressure was 28 MPa, and the temperature increase rate was 4° C./sec.

When the reaction time of 10 minutes was completed, the tube was placed in a water bath to stop the reaction. Subsequently, the content of the tube was taken out, filtered, and washed with water to obtain manganese dioxide. The resultant monocrystalline particles of manganese dioxide had a mean particle size of 8 μm.

(Preparation of Positive Electrode)

The manganese dioxide thus prepared, carbon black serving as a conductive agent, and fluorocarbon resin serving as a binder were mixed together in a weight ratio of 90:5:5 to form a positive electrode mixture. This positive electrode mixture was compression molded to produce a cylindrical positive electrode. The produced positive electrode was subjected to a heat treatment at 250° C. to remove water contained in the positive electrode before use.

(Preparation of Negative Electrode)

A rolled lithium plate was punched into a disc to produce a negative electrode.

(Preparation of Electrolyte)

An electrolyte was prepared by dissolving lithium perchlorate (LiClO₄) at a concentration of 1 mol/L in a solvent mixture of propylene carbonate and 1,2-dimethoxyethane in a volume ratio 1:1.

(Assembly of Battery)

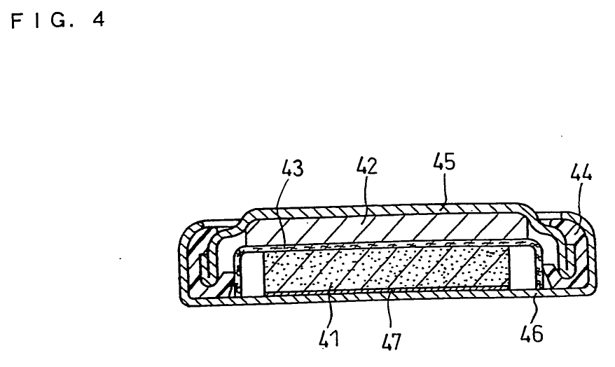

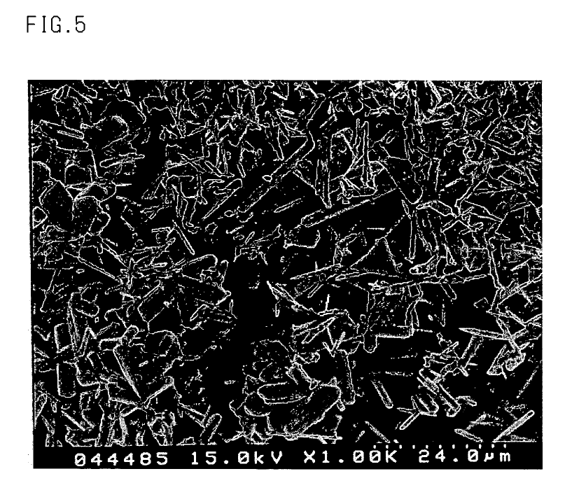

Using the positive electrode, negative electrode and electrolyte thus obtained, a coin battery with a structure as illustrated in FIG. 4 was produced in the following manner. The coin battery had an outer diameter of 20.0 mm and a thickness of 3.2 mm.

A negative electrode 42 was pressed to a sealing plate 45 combined with a gasket 44. Subsequently, a separator 43, which was a polypropylene non-woven fabric punched out into a circular shape, was disposed on the negative electrode 42. A positive electrode 41 was disposed thereon so as to face the negative electrode 42 with the separator 43 therebetween, and a predetermined amount of electrolyte was injected therein. A positive electrode case 46 was disposed over the positive electrode 41, and they were placed in a sealing die. By using a press, the open edge of the positive electrode case 46 was crimped onto the sealing plate 45 with the gasket 44 therebetween, to seal the opening of the positive electrode case 46. Note that carbon paint 47 had been applied between the positive electrode case 46 and the positive electrode 41.

The resultant battery was designated as a battery 1-1.

### EXAMPLE 1-2

A raw material aqueous solution was prepared by dissolving manganese nitrate and hydrogen peroxide in distilled water at 1 mol/L and 2 mol/L, respectively. Manganese dioxide was prepared in the same manner as in Example 1-1 except for the use of this raw material aqueous solution. The resultant monocrystalline particles of manganese dioxide had a mean particle size of 8 μm.

A battery 1-2 was produced in the same manner as in Example 1-1 except for the use of this manganese dioxide as a positive electrode active material.

### EXAMPLE 1-3

A battery 1-3 was produced in the same manner as Example 1-2, except that the amount of the raw material aqueous solution sealed in the tube was set to 4.12 cm³ (4.12 g) and that the reaction temperature was set to 250° C. The pressure during the reaction was 28 MPa. The resultant monocrystalline particles of manganese dioxide had a mean particle size of 20 μm.

### EXAMPLE 1-4

A battery 1-4 was produced in the same manner as Example 1-2, except that the amount of the raw material aqueous solution sealed in the tube was set to 3.74 cm³ (3.74 g) and that the reaction temperature was set to 300° C. The pressure during the reaction was 28 MPa. The resultant monocrystalline particles of manganese dioxide had a mean particle size of 15 μm.

### EXAMPLE 1-5

Manganese dioxide obtained in Example 1-1 and lithium hydroxide were mixed together in a molar ratio of 1:0.5. The resultant mixture was heat-treated at 400° C. to obtain a lithium-containing manganese oxide (Li_{0.5}MnO₂). The obtained lithium-containing manganese oxide was used as a positive electrode active material. A battery 1-5 was produced in the same manner as in Example 1-1 except that the obtained lithium-containing manganese oxide, carbon black serving as a conductive material and fluorocarbon serving as a binder were mixed at a weight ratio of 90:5:5 to form a positive electrode material mixture. The battery 1-5 is a secondary battery.

### EXAMPLE 1-6

Manganese dioxide obtained in Example 1-1 and lithium hydroxide were mixed together in a molar ratio of 1:0.5 to form a mixture. The mixture was heat-treated at 850° C. to obtain a manganese spinel (LiMn₂O₄). The obtained manganese spinel was used as a positive electrode active material. A battery 1-6 was produced in the same manner as in Example 1-1 except that the obtained manganese spinel, carbon black serving as a conductive material and fluorocarbon resin serving as a binder were mixed at a weight ratio of 90:5:5 to form a positive electrode material mixture. The battery 1-6 is a secondary battery.

### Comparative Example 1-1

Electrolytic manganese dioxide with a mean particle size of 30 μm was used as a positive electrode active material. Electrolytic manganese dioxide has a γ-type crystal structure containing a large amount of crystal water. Thus, by heat-treating the electrolytic manganese dioxide at 400° C., its crystal structure was changed to a β-type phase. A comparative battery 1-1 was produced in the same manner as in Example 1-1 except that the electrolytic manganese dioxide whose crystal structure was changed to a β-type phase, carbon black serving as a conductive material and fluorocarbon resin serving as a binder were mixed at a weight ratio of 90:5:5 to form a positive electrode material mixture.

### Comparative Example 1-2

Electrolytic manganese dioxide with a mean particle size of 30 μm and lithium hydroxide were mixed together in a molar ratio of 1:0.5. The resultant mixture was heat-treated at 400° C. to obtain a lithium-containing manganese oxide (Li_{0.5}MnO₂). A comparative battery 1-2 was produced in the same manner as in Example 1-1 except for the use of this lithium-containing manganese oxide as a positive electrode active material. The comparative battery 1-2 is a secondary battery.

### Comparative Example 1-3

Electrolytic manganese dioxide with a mean particle size of 30 μm and lithium hydroxide were mixed together in a molar ratio of 1:0.5. The resultant mixture was heat-treated at 850° C. to obtain a manganese spinel (LiMn₂O₄). A comparative battery 1-3 was produced in the same manner as in Example 1-1 except for the use of this manganese spinel as a positive electrode active material. The comparative battery 1-3 is a secondary battery.

The electrolytic manganese dioxide used in the comparative batteries 1-1 to 1-3 was agglomerated secondary particles with a polycrystalline structure. The mean crystallite size of this polycrystalline electrolytic manganese dioxide was approximately 0.2 μm. As used herein, the mean crystallite size refers to the mean particle size of primary particles contained in secondary particles. (Evaluation method of produced samples) The crystal structures of the manganese dioxides prepared in Examples 1-1 to 1-4 and the positive electrode active materials prepared in Examples 1-5 to 1-6 and Comparative Examples 1-1 to 1-3 were determined by X-ray diffraction analysis (XRD) using CuKa. The manganese dioxides and active materials produced were observed with a scanning electron microscope (SEM).

(Evaluation Results)

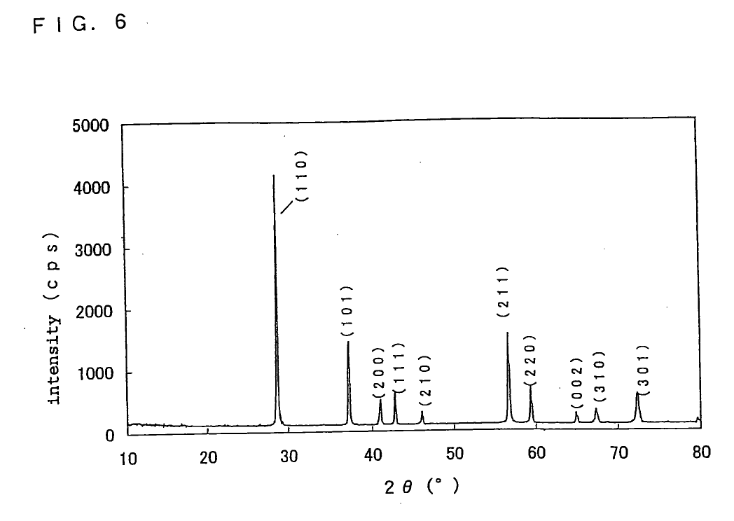

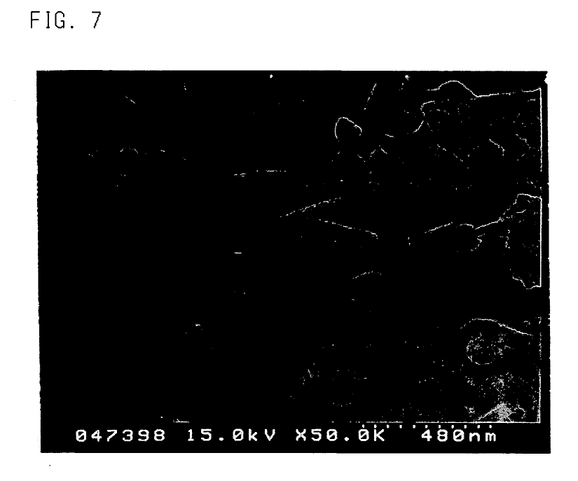

FIG. 5 shows an exemplary SEM photo of manganese dioxide prepared in Example 1-2, and FIG. 6 shows an X-ray diffraction chart thereof. The SEM photo of FIG. 5 and the X-ray diffraction chart of FIG. 6 show that the manganese dioxide used in the battery 1-2 contains little impurities and has very high crystallinity. Therefore, the manganese dioxide of the present invention is very preferable, for example, as a positive electrode material of lithium primary batteries.

The manganese dioxide monocrystalline particles obtained in Example 1-2 are mainly shaped like needles, as shown in the SEM photo of FIG. 5. The needle-like crystals had a length of 5 μm to 10 μm, with the average length (mean particle size) being 8 μm. The width of the needle-like crystals ranged from 1 μm to 2 μm. In Examples 1-3 and 1-4 where the reaction temperature was 374° C. or lower, the mean particle sizes of the manganese dioxide monocrystalline particles were 20 μm and 15 μm, respectively. That is, the mean particle sizes of the manganese dioxide monocrystalline particles of Examples 1-3 and 1-4 were larger than that of the manganese dioxide monocrystalline particles of Example 1-2.

Note that most of conventional manganese dioxide having a β-type crystal structure is polycrystalline particles, and manganese dioxide containing not less than 70 wt % of monocrystalline particles has not existed before.

Table 1 shows whether or not H₂O₂ was added to prepare manganese dioxides of the batteries 1-1 to 1-4, the reaction temperature, and the manganese dioxide yield. As used therein, the manganese dioxide yield refers to the percentage of the amount of manganese dioxide actually produced relative to the amount of manganese dioxide that can be theoretically produced.

TABLE 1

| | | Reaction | | |
|---|---|---|---|---|
| | Addition | temperature | | Yield |
| | of H₂O₂ | (° C.) | Product | (%) |
| Battery 1-1 | Not added | 400 | MnO₂ | 29 |
| Battery 1-2 | Added | 400 | MnO₂ | 90 |
| Battery 1-3 | Added | 250 | MnO₂ | 32 |
| Battery 1-4 | Added | 300 | MnO₂ | 56 |

The results of the batteries 1-1 and 1-2 in Table 1 show that the battery 1-2 with the addition of H₂O₂ has a higher manganese dioxide yield. This indicates that H₂O₂ serves as the oxidizing agent.

The results of the batteries 1-2 to 1-4 show that when the reaction temperature is in the range of 250 to 400° C., the manganese dioxide yield increases as the temperature increases. This indicates that the production of manganese dioxide is facilitated by taking the raw material aqueous solution to the subcritical or supercritical state.

When hydrogen peroxide was added to the raw material aqueous solution and the raw material aqueous solution was taken to the supercritical state (Example 1-2), the manganese dioxide yield was high. The reason for this result is probably as follows. The added hydrogen peroxide was thermally decomposed to produce oxygen gas, and the oxygen gas and the raw material aqueous solution formed a uniform phase, thereby allowing the oxidation of manganese ions to proceed smoothly.

(Evaluation of Primary Batteries)

Of each of the batteries 1-1 to 1-4 and comparative batteries 1-1, which are primary batteries, 10 batteries were discharged at a load resistance of 15 kΩ until the battery voltage lowered to 2.0 V, in order to determine their discharge capacities per unit weight of manganese dioxide. The average value of the obtained 10 discharge capacity values of each battery was calculated.

Of each of the batteries 1-1 to 1-4 and comparative battery 1-1, 20 batteries were preliminarily discharged to 75% of their discharge capacities. After the discharge, the internal resistance of each battery was measured by applying an alternating voltage of 1 kHz (AC impedance method), and the average value was calculated. Thereafter, each battery was stored at 60° C. for 40 days. It is believed that this storage condition corresponds to storage at room temperature for 2 years.

After the storage, the internal resistance was measured in the same manner as before the storage, and the average value was calculated. Table 2 shows the results. Table 2 shows the average value of discharge capacities per unit weight of manganese dioxide (expressed as “discharge capacity” in Table 2), the average value of internal resistances before storage, and the average value of internal resistances after storage (expressed as “internal resistance” in Table 2). Table 2 also shows whether or not H₂O₂ was added, the reaction temperature, and the mean particle size of manganese dioxide monocrystalline particles.

TABLE 2

| | | | Mean | | Internal | |
|---|---|---|---|---|---|---|
| | | Reaction | particle | Discharge | resistance (Ω) | |
| | Addition | temperature | size | capacity | Before | After |
| | of H₂O₂ | (° C.) | (μm) | (mAh/g) | storage | storage |
| Battery 1-1 | Not added | 400 | 8 | 275 | 11 | 21 |
| Battery 1-2 | Added | 400 | 8 | 280 | 12 | 15 |
| Battery 1-3 | Added | 250 | 20 | 265 | 10 | 33 |
| Battery 1-4 | Added | 300 | 15 | 271 | 9 | 25 |
| Comp. battery 1-1 | — | — | — | 260 | 11 | 112 |

The results of the batteries 1-1 to 1-4 and comparative battery 1-1 in Table 2 show that the manganese dioxides of the present invention have discharge capacities per unit weight that are larger than the conventional manganese dioxide by about 10 mAh or more. The reason is probably as follows. The manganese dioxides of the present invention have a monocrystalline or substantially monocrystalline structure and contain almost no grain boundaries in the particles. Thus, the diffusion of lithium ions in the solid phase was facilitated.

Also, the discharge capacity of the battery 1-2 is larger than that of the battery 1-1. This is probably because the H₂O₂ added to the raw material aqueous solution further increased the crystallinity of the resultant manganese dioxide, thereby improving the utilization rate.

The results of the battery 1-2 and the battery 1-3 indicate that as the reaction temperature for synthesis of manganese dioxide becomes higher, the discharge capacity becomes larger. This is probably because taking the raw material aqueous solution to the subcritical and, further, supercritical state to prepare manganese dioxide further increased the crystallinity of the resultant manganese dioxide, thereby improving the utilization rate.

The internal resistances after storage of the batteries 1-1 to 1-4 are low, compared with that of the comparative battery 1-1. This indicates that the manganese dioxides used in the batteries 1-1 to 1-4 are stable compared with that of the conventional manganese dioxide of the comparative battery 1-1. The reason is probably as follows. The manganese dioxides of the present invention have a monocrystalline or substantially monocrystalline structure, contain almost no crystal defects or lower oxides, and contain almost no sulfate ions or crystal water in the crystal structure. Thus, the elution of manganese from the manganese dioxide was suppressed, so that the internal resistance was prevented from increasing.

The internal resistance after storage of the battery 1-2 is smaller than that of the battery 1-1. This is probably because the H₂O₂ added to the raw material aqueous solution to prepare manganese dioxide further increased the crystallinity of the resultant manganese dioxide, thereby suppressing the elution of manganese.

The results of the battery 1-2 and the battery 1-3 indicate that as the reaction temperature becomes higher, the internal resistance after storage becomes lower. This is probably because taking the raw material aqueous solution to the subcritical or supercritical state further increased the crystallinity of the resultant manganese dioxide, thereby suppressing the elution of manganese.

(Evaluation of Secondary Batteries)

Of each of the battery 1-5 and the comparative battery 1-2, which are secondary batteries, 10 batteries were repeatedly charged and discharged at a current value of 0.1 mA within the battery voltage range of 2.5 to 3.5 V. The number of cycles at which the discharge capacity lowered to 50% of the discharge capacity at the 1st cycle (hereinafter also referred to as initial discharge capacity) was checked.

Likewise, of each of the battery 1-6 and the comparative battery 1-3, which are secondary batteries, 10 batteries were repeatedly charged and discharged at a current value of 0.1 mA within the battery voltage range of 3.5 to 4.5 V. The number of cycles at which the discharge capacity lowered to 50% of the initial discharge capacity was checked.

As a result, the obtained number of cycles for the battery 1-5 was about 20% higher than that for the comparative battery 1-2, and the obtained number of cycles for the battery 1-6 was about 25% higher than that of the comparative battery 1-3.

### EXAMPLE 2-1

Manganese dioxide was prepared by using the apparatus as illustrated in FIG. 2 and FIG. 3. Quartz glass was used as the insulating inorganic material of the inner wall 32 of the reaction tube 26. Also, stainless steel was used as the material of the first tube 23 and the second tube 24 and the material of the outer portion of the reaction tube 26.

An aqueous manganese nitrate solution of 0.05 mol/L was used as the raw material aqueous solution. This aqueous manganese nitrate solution was supplied at a predetermined pressure by the first supply unit 21. A hydrogen peroxide solution was prepared by dissolving hydrogen peroxide, which is the oxidizing agent, in distilled water at a concentration of 0.1 mol/L, and was supplied at a predetermined pressure by the second supply unit 22. While being supplied, the hydrogen peroxide solution was heated by the electric furnace 25 to prepare supercritical water.

The aqueous manganese nitrate solution and the supercritical water were joined together at the meeting point (MP) to form a reaction liquid. In order for the reaction liquid to have a temperature of 400° C. and a pressure of 30 MPa at the meeting point (MP), the electric furnaces 25 and 27 and the back-pressure regulating valve 30 had been adjusted. The temperature increase rate of the raw material aqueous-solution was 322° C./sec.

Subsequently, solid matter precipitated in the collecting means 29 was washed to obtain manganese dioxide. The monocrystalline particles of this manganese dioxide had a β-type crystal structure and a mean particle size of 0.4 μm.

Using the manganese dioxide thus obtained, a battery 2-1 was produced in the same manner as in Example 1-1.

### EXAMPLE 2-2

A battery 2-2 was produced in the same manner as in Example 2-1, except that manganese dioxide was prepared by using a 0.05 mol/L aqueous manganese nitrate solution without adding an oxidizing agent to distilled water. The temperature and pressure of the reaction liquid at the meeting point (MP) were the same as those in Example 2-1. The monocrystalline particles of manganese dioxide obtained in this example had a mean particle size of 0.4 μm.

### EXAMPLE 2-3

A battery 2-3 was produced in the same manner as in Example 2-1, except that manganese dioxide was prepared by adjusting the temperature of the reaction liquid at the meeting point (MP) to 300° C. The pressure of the reaction liquid at the meeting point (MP) was the same as that in Example 2-1. The monocrystalline particles of manganese dioxide obtained in this example had a mean particle size of 0.7 μm.

### EXAMPLE 2-4

A battery 2-4 was produced in the same manner as in Example 2-1, except that manganese dioxide was prepared by adjusting the temperature of the reaction liquid at the meeting point (MP) to 250° C. and setting the pressure to 30 MPa. The monocrystalline particles of manganese dioxide obtained in this example had a mean particle size of 0.9 μm.

### EXAMPLE 2-5

Manganese dioxide obtained in Example 2-1 and lithium hydroxide were mixed together in a molar ratio of 1:0.5 to form a mixture. The mixture was heat-treated at 400° C. to obtain a lithium-containing manganese oxide (Li_{0.5}MnO₂). A battery 2-5 was produced in the same manner as in Example 2-1 except for the use of this lithium-containing manganese oxide as a positive electrode active material. The battery 2-5 is a secondary battery.

### EXAMPLE 2-6

Manganese dioxide obtained in Example 2-1 and lithium hydroxide were mixed together in a molar ratio of 1:0.5 to form a mixture. The mixture was heat-treated at 850° C. to obtain a manganese spinel (LiMn₂O₄). A battery 2-6 was produced in the same manner as in Example 2-1 except for the use of this manganese spinel as a positive electrode active material. The battery 2-6 is a secondary battery.

(Evaluation Method of Produced Samples)

The crystal structure, shape, etc. of the manganese dioxides prepared in Examples 2-1 to 2-4 and the positive electrode active materials prepared in Examples 2-5 to 2-6 were analyzed in the same manner as the above.

(Evaluation Results)

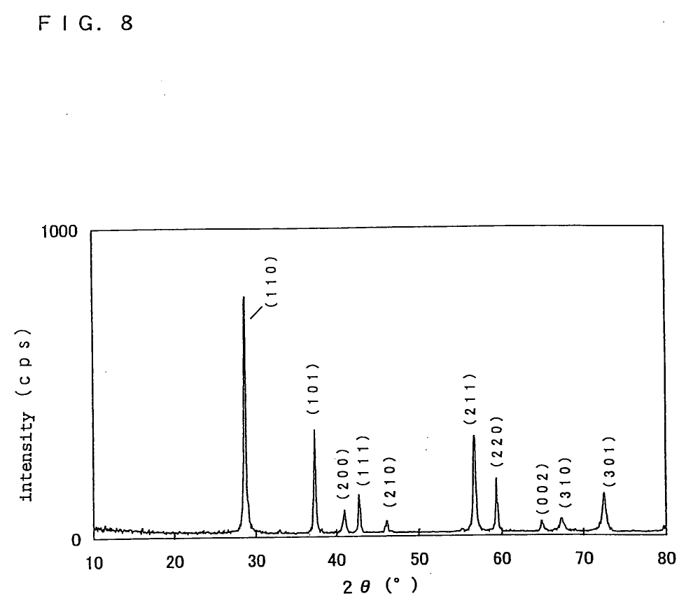

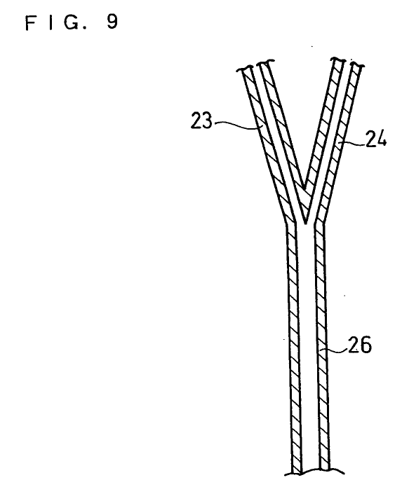

FIG. 7 shows an exemplary SEM photo of manganese dioxide prepared in Example 2-1 and FIG. 8 shows an X-ray diffraction chart thereof.

FIGS. 7 and 8 show that the manganese dioxide obtained in Example 2-1 consists essentially of fine needle-like particles of high monocrystallinity containing almost no impurities. Further, the monocrystalline particles of manganese dioxide of Example 2-1 had a mean particle size of 0.4 μm. On the other hand, the monocrystalline particles of manganese dioxide obtained in Example 1-2 had a mean particle size of 8 μm, as shown in FIG. 5. Therefore, the manganese dioxide of Example 2-1 is fine particles of a smaller mean particle size and is very preferable as a positive electrode material of lithium primary batteries.

It should be noted that when the reaction temperature is 374° C. or less, the mean particle size of the resultant manganese dioxide tended to be large.

Table 3 shows whether or not H₂O₂ was added, the reaction temperature, and the manganese dioxide yield, in the production of manganese dioxides of Examples 2-1 to 2-4.

TABLE 3

| | | Reaction | | |
|---|---|---|---|---|
| | Addition | temperature | | Yield |
| | of H₂O₂ | (° C.) | Product | (%) |
| Battery 2-1 | Added | 400 | MnO₂ | 95 |
| Battery 2-2 | Not added | 400 | MnO₂ | 35 |
| Battery 2-3 | Added | 300 | MnO₂ | 67 |
| Battery 2-4 | Added | 250 | MnO₂ | 41 |

The results of Example 2-1 and Example 2-2 show that Example 2-1 where the reaction liquid contains H₂O₂ has a higher manganese dioxide yield. This indicates that the H₂O₂ serves as the oxidizing agent. This is probably because the hydrogen peroxide was thermally decomposed in the supercritical state to produce oxygen gas and this oxygen gas and the aqueous solution containing manganese ions formed a uniform phase, thereby facilitating the oxidation of the manganese ions.

The results of Example 2-1, Example 2-3 and Example 2-4 show that in the temperature range of 250 to 400° C., as the temperature becomes higher, the yield becomes higher. This indicates that taking an aqueous solution containing manganese ions to the subcritical and, further, supercritical state facilitates the production of monocrystalline particles of manganese dioxide with a small mean particle size.

(Evaluation Method of Primary Batteries)

The batteries 2-1 to 2-4, which are primary batteries, were examined in the same manner as the above to determine their discharge capacities and internal resistances before and after storage. Table 4 shows the results together with the results of the battery 1-2 and the comparative battery 1-1. Table 4 also shows whether or not H₂O₂ was added, the reaction temperature, and the mean particle size of the monocrystalline particles of manganese dioxide.

TABLE 4

| | | | Mean | | Internal | |
|---|---|---|---|---|---|---|
| | | Reaction | particle | Discharge | resistance (Ω) | |
| | Addition | temperature | size | capacity | Before | After |
| | of H₂O₂ | (° C.) | (μm) | (mAh/g) | storage | storage |
| Battery 2-1 | Added | 400 | 0.4 | 300 | 7 | 16 |
| Battery 2-2 | Not added | 400 | 0.4 | 295 | 8 | 23 |
| Battery 2-3 | Added | 300 | 0.7 | 285 | 9 | 26 |
| Battery 2-4 | Added | 250 | 0.9 | 280 | 10 | 32 |
| Battery 1-2 | Added | 400 | 8 | 280 | 12 | 15 |
| Comp. battery 1-1 | — | — | — | 260 | 11 | 112 |

The results of the batteries 2-1 to 2-4 and the comparative battery 1-1 show that the batteries using the manganese dioxide consisting essentially of monocrystalline particles with a mean particle size of 0.1 μm or more and 10 μm or less have discharge capacities that are higher than that of the comparative battery 1-1 using conventional electrolytic manganese dioxide by about 20 mAh or more. The reason is probably as follows. The manganese dioxides used have a monocrystalline or substantially monocrystalline structure, so the manganese dioxide particles have almost no grain boundaries. Further, the manganese dioxide particles have a small mean particle size. Therefore, the lithium ions need to move only a short distance inside the manganese dioxide particles and can diffuse smoothly inside the manganese dioxide particles. As a result, the discharge capacity improved.

Also, the discharge capacity of the battery 2-1 is larger than that of the battery 2-2. This is probably because the H₂O₂ contained in the reaction liquid increased the crystallinity of the manganese dioxide, thereby improving the utilization rate thereof.

The results of the battery 2-1 and the batteries 2-3 and 2-4 indicate that as the reaction temperature becomes higher, the battery discharge capacity becomes higher. This is probably because taking the aqueous solution containing manganese ions to the subcritical or supercritical state increases the crystallinity of the manganese dioxide, thereby improving the utilization rate thereof.

The discharge capacities of the batteries 2-1 to 2-4 are equivalent to or larger than that of the battery 1-2. This is probably because reducing the mean particle size of the monocrystalline particles of manganese dioxide to 0.1 to 1 μm reduced the diffusion distance of the lithium ions, thereby improving the utilization rate.

The internal resistances after storage of the batteries 2-1 to 2-4 are lower than that of the comparative battery 1-1. This is probably due to the same reason as those described above. That is, the manganese dioxides of the present invention have a monocrystalline or substantially monocrystalline structure, contain no crystal defects or lower oxides, and contain no sulfate ions or crystal water in the crystal structure. Thus, the elution of manganese was suppressed, so that the internal resistance is prevented from increasing.

The internal resistance after storage of the battery 2-1 is smaller than that of the battery 2-2. This is probably because the H₂O₂ contained in the reaction liquid increased the crystallinity of the manganese dioxide, thereby suppressing the elution of manganese.

The results of the battery 2-1 and the batteries 2-3 and 2-4 indicate that as the reaction temperature becomes higher, the internal resistance after storage becomes lower. This is probably because taking the aqueous solution containing manganese ions to the subcritical or supercritical state increased the crystallinity of the manganese dioxide, thereby suppressing the elution of manganese.

(Evaluation of Secondary Batteries)

The batteries 2-5 and 2-6, which are secondary batteries, were also examined in the same manner as the above to obtain the number of cycles at which the discharge capacity lowered to 50% of the initial discharge capacity.

The obtained number of cycles for the battery 2-5 was about 20% higher than that of the comparative battery 1-2. Also, the obtained number of cycles for the battery 2-6 was about 25% higher than that of the comparative battery 1-3.

As described above, it is understood that the manganese dioxides of the present invention provide better discharge capacities and lower internal resistances after storage than those of the battery containing conventional manganese dioxide. Further, it is understood that even when the manganese dioxide of the present invention is used as the starting substance to prepare a positive electrode active material for secondary batteries, the resultant positive electrode active material has the characteristics of the manganese dioxide of the present invention, and that the use of such a positive electrode active material in a battery improves the charge/discharge cycle life of the battery.

It should be noted that even when the manganese dioxide of the present invention is mixed with another active material, the above-described effects can be obtained. In this case, it is preferred that the manganese dioxide of the present invention constitutes not less than 10% by weight of the active material mixture.

### EXAMPLE 2-7

Manganese dioxide was prepared in the same manner as in Example 2-1 except for the use of a reaction tube whose inner wall was made of alumina. In this example, the temperature and pressure of the reaction liquid at the meeting point (MP) were made the same as those of Example 2-1. The monocrystalline particles of manganese dioxide obtained in this example had a mean particle size of 0.4 μm. Comparative Example 2-1 and Comparative Example 2-2 The apparatus as illustrated in FIG. 2 was used. In Comparative Example 2-1, the reaction tube was composed only of stainless steel. In Comparative Example 2-2, the reaction tube was composed only of copper. The first tube and the second tube were connected to the inlet of the reaction tube, as illustrated in FIG. 9.

The synthesis of manganese dioxide was started in the same manner as in Example 2-1 except for the use of the above-mentioned apparatuses. However, the apparatus (reaction tube) of Comparative Example 2-1 was clogged with the produced manganese dioxide 40 minutes after the start of synthesis, and the apparatus of Comparative Example 2-2 was clogged with the manganese dioxide 30 minutes after the start of synthesis.

In the apparatuses used in Examples 2-1 and 2-7, no precipitation of manganese dioxide was found on the inner wall of the reaction tube even after the synthesis of manganese dioxide was continued for 5 hours. Accordingly, it is preferred to use an insulating inorganic material such as quartz glass or alumina as the material of the inner wall of the reaction tube, because such materials can suppress the precipitation of manganese dioxide on the inner wall of the reaction tube.

As described above, the manganese dioxide of the present invention reduces the occurrence of problems such as increased battery internal resistance and insufficient discharge, because the elution of manganese is suppressed during discharge. The use of such manganese dioxide makes it possible to improve the life characteristics and reliability of the battery.

By taking an aqueous solution containing manganese ions to the subcritical or supercritical state, it is possible to synthesize manganese dioxide with extremely high monocrystallinity. Particularly when nitric acid ions and oxygen gas coexist in a reaction field as the oxidizing agents in the supercritical state, the aqueous solution containing manganese ions and the oxygen gas can form a uniform phase, so that manganese dioxide can be synthesized with high yields. Also, since particles with a mean particle size of 20 μm or less are produced, a pulverization step is unnecessary, so that it is possible to save pulverization energy. Accordingly, the above-described methods can provide monocrystalline particles of manganese dioxide that can improve battery characteristics at high speed, high efficiency, and low energy consumption.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. Manganese dioxide comprising monocrystalline particles with a β-type crystal structure.

2. The manganese dioxide according to claim 1, wherein said monocrystalline particles have a mean particle size of 0.1 μm or more and 1 μm or less.

3. The manganese dioxide according to claim 1, wherein said monocrystalline particles are shaped like needles.

4. A method for producing manganese dioxide, comprising the step of taking an aqueous solution containing manganese ions to a subcritical or supercritical state to thereby precipitate manganese dioxide.

5. The method according to claim 4, wherein said aqueous solution containing manganese ions is heated at a temperature increase rate of 300° C./sec or more to thereby take it to a subcritical or supercritical state.

6. The method according to claim 5, wherein said aqueous solution containing manganese ions is directly mixed with subcritical or supercritical water to thereby heat it at the temperature increase rate of 300° C./sec or more.

7. The method according to claim 4, wherein an oxidizing agent is dissolved in said aqueous solution containing manganese ions, and said oxidizing agent comprises at least one selected from the group consisting of oxygen gas, ozone gas, hydrogen peroxide, and a nitric acid ion.

8. The method according to claim 6, wherein an oxidizing agent is dissolved in said subcritical or supercritical water, and said oxidizing agent comprises at least one selected from the group consisting of oxygen gas, ozone gas, hydrogen peroxide, and a nitric acid ion.

9. An apparatus for producing manganese dioxide, comprising: a reaction tube with an inlet and an outlet; a first tube connected to said inlet of said reaction tube, said first tube being provided for supplying an aqueous solution containing manganese ions to said reaction tube; a second tube connected to said inlet of said reaction tube, said second tube being provided for supplying subcritical or supercritical water to said reaction tube; and means for collecting manganese dioxide, said means being provided downstream of said outlet of said reaction tube,
wherein said aqueous solution containing manganese ions is mixed with said subcritical or supercritical water at said inlet of said reaction tube,
and said reaction tube has an inner wall comprising an insulating inorganic material.

10. The apparatus according to claim 9, wherein said insulating inorganic material is quartz or alumina.

11. A positive electrode active material for a battery, comprising the manganese dioxide of claim 1.

12. A positive electrode active material for a battery, which is synthesized by baking the manganese dioxide of claim 1 and a lithium compound.

13. A battery comprising: a positive electrode comprising the positive electrode active material of claim 11 or 12; a negative electrode; a separator; and an electrolyte.

14. Manganese dioxide in accordance with claim 1, comprising not less than 70 wt % of said monocrystalline particles with a β-type crystal structure.
